(19) United States
(12) Patent Application Publication
(10) Pub. No.: US 2014/0039910 A1
(43) Pub. Date: Feb. 6, 2014

(54) Controlled Communications System for Physician-Hospital System Integration

(71) Applicant: Navio Health, LLC, Newark, NJ (US)

(72) Inventors: Adam Turinas, Chatham, NJ (US); Stuart M. Hochron, Jersey City, NJ (US)

(21) Appl. No.: 13/913,951

(22) Filed: Jun. 10, 2013

Related U.S. Application Data
(60) Provisional application No. 61/677,845, filed on Jul. 31, 2012.

(51) Int. Cl. H04L 29/06; G06Q 50/22

(52) U.S. Cl. CPC H04L 63/08; G06Q 50/22
USPC 705/2

(57) ABSTRACT

An integrated digital communications system having HIPAA compliant text and email capability that complies with medical record maintenance requirements and facilitates physician/provider utilization of a healthcare system's resources is presented. The mobile platform capabilities include selection of physician/providers based on specialty and medical insurance plan participation, the scheduling of physician/provider referrals and medical procedures, healthcare provider to healthcare provider communications, medical billing, pharmacy formulary inquiry and ordering, reporting of physician/provider location, and provision of medical information and delivering news and alerts. The system includes a smart-device App that verifies users, encrypts and decrypts electronic messages, and transmits and receives electronic messages. Encrypted messages are securely stored, and automatically incorporated into patient healthcare records. The App provides a digital communication platform that integrates messaging capabilities with a hospital scheduling system to facilitate quick and easy scheduling of medical procedures and physician/provider consultations.

### CLAIM OF PRIORITY

This application claims the priority of U.S. Ser. No. 61/677,845 filed on Jul. 31, 2012, the contents of which are fully incorporated herein by reference.

### FIELD OF THE INVENTION

The invention relates to a controlled, integrated communications platform or system, and more particularly to a digital communications system incorporating mobile devices, secure encryption and secure storage that satisfy both State and Federal regulations and guidelines for secure maintenance and transmission of protected patient health information.

### BACKGROUND OF THE INVENTION

Medical practitioners and hospital systems would like to utilize the ease and speed of modern communication devices and techniques such as, but not limited to, the texting and/or email capabilities of mobile smartphones and tablets. Health professionals must, however, ensure that any communications containing a patient's protected health information (PHI) is exchanged in a secure manner that complies with all relevant US Federal regulations, including the regulations mandated by the US Health Insurance Portability and Accountability Act (HIPAA). HIPAA compliance is stringent and requires, for instance, that any PHI, i.e., any information regarding the health status, the provision of health care, or the payment for healthcare, that can be linked to a specific individual, must be maintained in a secure and accountable manner at all times. As conventional smartphone texting and emailing typically involves data being transferred through one or more unsecure servers in an un-encrypted form, conventional smartphone texting and emailing is not HIPAA compliant.

In addition to being HIPAA compliant, information exchanged by physicians and other healthcare professionals regarding a patient's treatment is typically regarded as PHI, is part of the patient's medical record, and as such is typically required by State law, or health provider regulations, to be stored in a manner that conforms to standards of, for instance, data integrity and authentication. This includes practices such as, but not limited to, locking entries to protect data from accidental or unauthorized alteration and the validation of the correctness of all information including the identities of all parties involved including the patient, the physician/providers and the time and date of any communication.

In addition to these compliance concerns, healthcare providing institutions and systems have a vested interest in attempting to integrate with physician/providers and facilitate: a) incoming referrals for medical procedures, b) physician/provider consultation from physician/providers inside of their hospital system network of doctors, c) to minimize the number of referrals leaving their network of in-system doctors to physician/providers outside of the health care system provider-network and d). to coordinate patient care. These objectives may be met by having a communications systems that incorporates easy access to, and easy scheduling with, physician/providers in the healthcare network that participate with a patient's healthcare insurance.

The present invention accomplishes all of these communications requirements, as discussed in more detail below.

### DESCRIPTION OF THE RELATED ART

US Patent Application 20090254971 submitted by F. Herz et al. on Oct. 8, 2009 entitled “Secure Data Interchange” that describes a secure data interchange system which enables information about bilateral and multilateral interactions between multiple persistent parties to be exchanged and leveraged within an environment that uses a combination of techniques to control access to information, release of information, and matching of information back to parties. Access to data records can be controlled using an associated price rule. A data owner can specify a price for different types and amounts of information access.

US Patent Application 20060282395 submitted by J. Leibowitz on Dec. 14, 2006 entitled “Methods for using a mobile communications device in consumer, medical and law enforcement transactions” that describes a system and methods to integrate, secure and simplify transaction conducted by means of a mobile electronic communications device such as a cell phone or smartphone, combining biometric identification, computer software applications resident in the device's memory, PAN (personal area network) and data storage and transmission means, such system and methods being useful in credit or debit card transactions, automated transmission and retrieval of private medical information and the retrieval of law enforcement data, among other possible uses, purposes and applications.

US Patent Application 20060195342 submitted by M. Khan et al. on Aug. 31, 2006 entitled “Method and system for providing medical healthcare services” that describes a method for ordering over a network one or more tests for a medical condition for a patient, the method including the steps of providing to the user over the network one or more tests for the patient that can be selected, allowing a user to select over the network one or more tests, determining whether a constraint exists on ordering any of the selected tests; ordering the selected tests over the network, obtaining a result of each of the ordered tests, and providing an automated evaluation based upon feedback resulting from the ordered tests. Using the methods and systems described, a user, such as a physician/provider, can easily obtain information over a network about a large number of tests and order any of the tests over the network. The server can also obtain payment and related information from the user at the time the one or more tests are ordered.

US Patent Application 20110191122 submitted by O. Kharraz-Tavakol et al. on Aug. 4, 2011 entitled “Method and Apparatus for Managing Physician Referrals” that describes a method and apparatus for managing the physician referral process, whereby a referring physician (e.g., a primary care provider) refers a patient to another physician (e.g., a specialist) for a particular medical procedure, analysis or care. An aggregator provides systems and methods available to physicians and their administrative staff (herein collectively referred to as physicians or doctors) to: book appointments on behalf of their patients online through a doctor directory and calendar function; filter available doctors by specialty, subspecialty, procedure, insurance participation and/or hospital network; transfer a patient's personal information, medical history and pre-selected insurance forms from one doctor's office to another's, electronically; transfer and upload relevant forms and paperwork via fax from one doctor's office to another; track referrals historically (over time) on a by-doctor or by-patient basis; facilitate referrals to and from doctors in a certain network or group.

Various other implementations are known in the art, but also fail to address all of the problems solved by the invention entitled “Controlled Communications System for Physician-Hospital System Integration” that is described herein. One embodiment of the present invention is illustrated in the accompanying drawings and will be described in more detail herein below.

### SUMMARY OF THE INVENTION

The present invention concerns a controlled, integrated digital communications system that may be used in a healthcare system to provide HIPAA compliant text and/or email communications between practitioners, patients, healthcare personnel and hospital administrators, while complying with medical record maintenance requirements and also facilitating physician/providers utilization of a set of services and physician/providers associated with the healthcare system.

As used herein the term “healthcare system” is the organization of people, institutions, and resources to deliver health care services to meet the health needs of target populations. In one preferred embodiment the healthcare system is the organization of people, institutions, and resources associated with a particular hospital. In another embodiment, the healthcare system is the organization of people, institutions, and resources associated with a group of two or more hospitals, or an insurance organization or group of two or more insurance organizations. Other types of organizations that deliver health care services may also qualify as a healthcare systems, the primary component being a group of physicians/providers needing communication, scheduling and/or referral services.

In a preferred embodiment, the controlled, integrated digital communications system of the present invention may also provide a mobile platform for the billing of physician/provider services, the tracking of physician/provider location within a hospital system, and delivering news and alerts to physician/providers and other hospital personnel.

In a preferred embodiment, the controlled communications system may include mobile smart-device Apps that may be machine executable instructions that enable a mobile smart-device to perform various functions.

The functions the mobile smart-device may perform may include, but are not limited to, functions such as verifying that a user is an authorized user of the mobile smart-device, and then securely encrypting any electronic message that may contain information related to a patient. The messages may be any electronic messages such as, but not limited to, text messages, emails, images or some combination thereof. The mobile smart-device may then transmit the electronic message to an identified recipient, and may receive an electronic confirmation that the message has been received.

In a preferred embodiment, the electronic message may then be tagged with any necessary identification information such as, but not limited to, the user's identity, the patient's identity, the recipient's identity and the confirmation of receipt. The tagged message may then be stored in a secure digital storage unit that may be operated by the healthcare system.

In a preferred embodiment, the App may also enable the smart device to receive and decrypt incoming messages, and automatically transmit confirmations of receipt when the messages are read. The App may also automatically cause the tagged electronic message to be incorporated into the patient's health care record. The App may provide an integrated digital communication platform that integrates the messaging capabilities with the hospital scheduling system in order to facilitate quick and easy scheduling of medical procedures and physician/provider consultations.

The controlled, integrated digital communications system may be used for any suitable medical purpose such as, but not limited to, the referral of a patient from one physician/provider to another physician/provider, the scheduling of procedures, and communications between healthcare providers. By having an easily accessible database of in-system physician/providers indexed by factors such as their specialty, their names and the insurance plans they accept, the controlled, integrated digital communications system may facilitate patient referrals to in-system physician/providers.

The controlled communications system of this invention may further help a healthcare provider manage his/her PHI information security by allowing the App to receive instructions from a central controller that may lock the mobile smart-device and thereby prevent stolen or lost devices being used by unauthorized users.

Therefore, the present invention succeeds in conferring the following, and others not mentioned, desirable and useful benefits and objectives.

It is an object of the present invention to provide HIPAA compliant texting and emailing thereby coordinating all medical providers within a healthcare system.

It is another object of the present invention to provide a means for healthcare systems to facilitate physician/provider's use of the services of the system and its in-system specialists.

Yet another object of the present invention is to provide a secure, automated means of updating and storing patient records with communications from physician/providers.

A further objective of the system is to provide healthcare providers with a secure, HIPAA compliant platform for discussing patient-related healthcare matters using electronic communications including texting and email.

### BRIEF DESCRIPTION OF THE DRAWINGS

FIG. 1 shows a schematic overview of the controlled communications system of the present invention.

FIG. 2 shows a further schematic overview of the controlled communications system of the present invention.

FIG. 3 shows a flow diagram of representative steps of the functioning of the controlled communications system of the present invention.

### DESCRIPTION OF THE PREFERRED EMBODIMENTS

The preferred embodiments of the present invention will now be described with reference to the drawings. Identical elements in the various figures are identified with the same reference numerals.

Various embodiments of the present invention are described in detail. Such embodiments are provided by way of explanation of the present invention, which is not intended to be limited thereto. In fact, those of ordinary skill in the art may appreciate upon reading the present specification and viewing the present drawings that various modifications and variations can be made thereto.

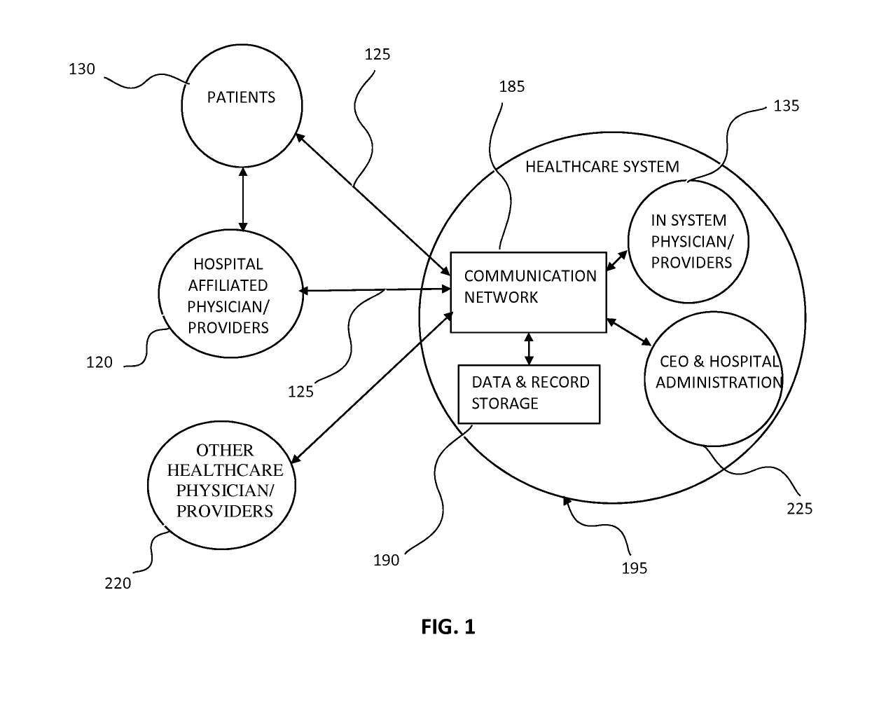

FIG. 1 shows a schematic overview of the controlled communications system of the present invention.

The controlled, integrated digital communications system may include a central controller 185 that provides secure HIPAA compliant communication between a variety of authorized users 120, who may constitute a hospital system, and an identified recipient 135 such as, but not limited to, one or more hospital system employed physician/providers, patients, the CEO and the hospital administration staff, affiliated physician/providers and other healthcare providers.

In a preferred embodiment, the controlled, integrated digital communications system may also provide authorized users with access to a secure digital storage unit 190 that may, for instance, be used to securely store patient medical records as well as billing information, formulary information, personnel information and general medical information.

The healthcare system 195 may, for instance, be a hospital, a group of hospitals, a collection of practitioners or some combination thereof that may all be affiliated as a corporate entity.

The controlled communications system 100 may, for instance, provide electronic messaging 125 capabilities between the members of the healthcare system 195 and their affiliates in a secure, encrypted and controlled manner so that all the communications, including text messages and email messages, are both HIPAA compliant and meet all relevant standards for the care of protected health information (PHI).

The term physician/provider may, for instance, include any State or Federal licensed medical practitioner such as, but not limited to, Medical Doctors (MD), Doctors of Osteopathy (DO) and practitioners of Complementary and Alternative Medicine (CAM) such as, but not limited to, primary care physicians and specialty physician/practitioners such as, but not limited to, cardiologists, pulmonologists, nephrologists, neurologists, endocrinologists, gastroenterologists, dermatologists, general surgeons, ENT surgeons, cardio-thoracic surgeons, vascular surgeons, ophthalmologists, obstetricians, colorectal surgeons, dentists, oral surgeons, orthopedists, neurosurgeons, podiatrists, psychiatrists, chiropractors, acupuncturists and others

The term physician/provider may also, for instance, include medical practitioners not having MD, OD or CAM licenses such as, but not limited to, optometrists, pharmacists, respiratory therapists, occupational therapists, nurses, physician extenders, nurse practitioners, physician assistants and others.

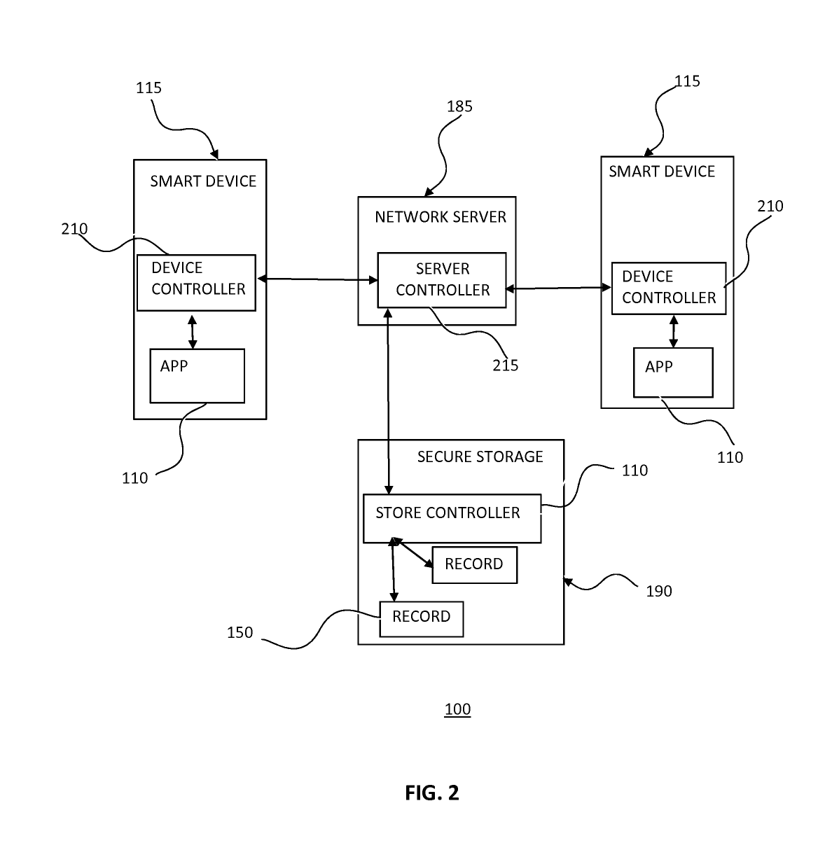

FIG. 2 shows a further schematic overview of the controlled communications system of the present invention.

In a preferred embodiment, the controlled, integrated digital communications system 100 may include one or more mobile smart-devices 115, a central controller 185 and a secure digital storage unit 190.

The mobile smart-device 115 may, for instance, be any suitable digital communications device such as, but not limited to, a mobile phone, a smart phone, a tablet, a computer, a landline or some combination thereof. The mobile smart-device 115 may, for instance, have a device controller module 210 that may be a combination of hardware and software that is configured to provide digital communication capability such as, but not limited to, voice, voice-mail, email, texting, images, video or some combination thereof.

An application, or App, may be configured to operate on the mobile smart-device 115 and may include machine executable instructions 110 designed to enable the mobile smart-device to perform a variety of functions. These functions may include operations such as, but not limited to, identifying of any user attempting to use the device, securely encrypting any electronic messages regarding a patient having a patient identity prior to transmitting messages to an identified recipient, receiving an electronic confirmation of receipt from the recipient, or the recipient's mobile smart-device, tagging the message with information that may include a user identity, a patient identity and the electronic confirmation of receipt, causing the tagged electronic message to be stored in a secure digital storage unit that may be operated by the healthcare system, receiving and decrypting an encrypted electronic message, transmitting an electronic confirmation of the receipt of a message, or some combination thereof.

The communications to and from the mobile smart-devices 115 may be mediated by a suitable central controller 185 that may include a server controller module 215 that may be software, hardware or a combination thereof.

The central controller 185 and its associated operation instructions modules may, for instance, monitor any messages transmitted or received by any of the mobile smart-devices 115 associated with the controlled, integrated digital communications system 100. This monitoring may, for instance, take the form of monitoring one or more encrypted messages and/or monitoring any meta-data associated with the one or more messages. As a result of such monitoring, the central controller 185 may automatically associate the message with a designated record set that may be associated with an identified patient, an identified user or a function related database or some combination thereof. The results of such actions may be designed to make the controlled, integrated digital communications system HIPAA compliant, and may include the storing of a designated record sets 150 on a secure digital storage unit 190 by means of a store controller that may include suitable machine executable instructions 110.

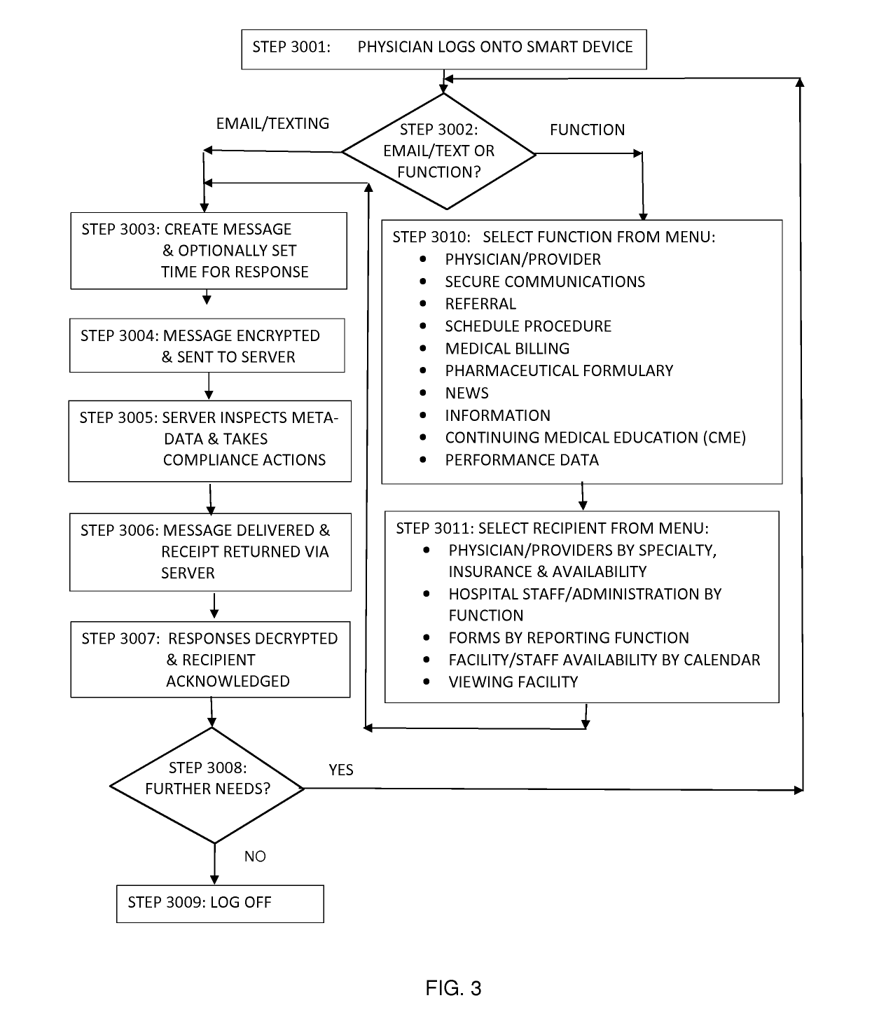

FIG. 3 shows a flow diagram of representative steps of the functioning of the controlled communications system of the present invention.

In step 3001: “Physician logs onto smart device”, a user may be required by the App running on the mobile smart-device 115 to identify themselves as a bona-fide authorized user of the controlled, integrated digital communications system. This authorization may, for instance, use a standard challenge response approach that may be a username/password combination, or it may involve biometric information such as, but not limited to, a fingerprint, a retina scan, an image or some combination thereof.

In step 3002, “Email/text or function?” the authorized user may now select whether to user the mobile smart-device 115 merely as a communications device by selecting email/texting, or to access one of the many other functions supported by the controlled, integrated digital communications system 100.

In step 3003: “Create message and optionally set time for response”, the user may create a message using a real or virtual keyboard, a menu of pre-prepared messages, a voice recognition system, or some combination thereof. In a preferred embodiment, the user may also have the option to enter a “time for a response”, i.e., a specific period of time that may be allowed to elapse from the transmission of the message to the receipt of the message.

In step 3004: “Message encrypted and sent to server” the App may encrypt the message using any suitable encryption method, but preferably a public key encryption systems such as, but not limited to, the well-known RSA encryption system. Once encrypted the message may be sent to the central controller 185 in a digital form using any suitable transmission method such as, but not limited to, wireless transmission, fixed line transmission, optical or co-axial fiber transmission, satellite transmission or some combination thereof.

In step 3005: “Server inspects message meta-data and takes any necessary compliance actions” the central controller 185 may monitor the incoming message by examining the encrypted message, by decrypting the message and examining the text of the message, by examining the meta-data or any tagged information associated with the message, or some combination thereof.

Based on examination of the message, the central controller 185 may take appropriate action such as, but not limited to, storing a copy of the message in encrypted or unencrypted form, or a combination thereof, on a secure digital storage unit 190, updating an appropriate database with information gained from the message or some combination thereof. A store controller that may include a suitable set of machine executable instructions 110, may facilitate storage of the copies of the message. The storage of the data may, for instance, be in the form of a designated record set 150 that may be HIPAA compliant and/or compliant with any relevant corporate, state or federal laws or regulations, or some combination thereof.

In step 3006: “Message delivered and receipt returned to sender via server”; the server may now forward a copy of the message to the intended recipient or recipients. The server may also send a notification back to the sender confirming that the message has been received by the server and transmitted on to the intended recipient(s). The recipient(s) may send a similar notice of receipt-of-message back to the server and/or the sender when the message is accessed on the recipient's mobile smart-device 115.

In step 3007: “Any incoming responses decrypted and recipient altered”, the App operable on the user's mobile smart-device 115 may accept any incoming messages, such as, but not limited to, responses to outgoing messages and notices of receipt, or some combination thereof. Incoming messages may be decrypted in full or in part, and may be displayed to the user in either fully or partially encrypted form. The App may also automatically transmit acknowledgements of receipt back to the server and/or the sender that the message has been received.

In step 3008 “Further needs?” the user may elect to end their use of the controlled, integrated digital communications system and proceed to step 3009 “Log off”. In this step the user may, for instance, exit from the system app and proceed to use the mobile smart-device in an unregulated manner.

If, in step 3008, the user elects to use the controlled, integrated digital communications system for further functions or communications, they may then loop back to step 3002 “Email/text or function?”

If they now elect to use a function of the controlled, integrated digital communications system 101, they may proceed to Step 3010: “Select function from a menu that may include: Contact, Referral, Schedule Procedure, Medical Billing, Pharmacy Formulary, News or Information, Continuing Medical Education and Performance Data, or some combination thereof.

These functions may, for instance, include the ability to request and/or order physician and provider consultation, order patient medication and other forms of therapy and to request, order or schedule patient outpatient procedures. Other functions may, for instance, include communicating performance data on a regular basis to physicians and other providers, providing Continuing Medical Education (CME) in video and other formats to physicians and other providers and connecting physicians and other providers to other medically-related entities, including insurance and business entities.

Once one of the function options is selected, the user may then proceed to step 3011 to access appropriate databases of information or resources.

For instance, if in step 3011 “Select intended recipient from menu that may include: physician/providers by specialty, insurance & availability, hospital staff/administration by function, forms by reporting function, facility/staff availability by calendar”.

If the user elects either a “Referral” or a “Schedule Procedure” function, they may first be presented with a menu that may access a database of physician/providers by categories such as, but not limited to, their specialty, the medical insurance coverage they participate in or their availability or some combination thereof.

The user, or referring physician/provider, may then make a suitable selection, i.e., they may have a patient requiring a specific type of specialty care and who is eligible for a certain medical insurance plan, and use the database to select an available in-system physician/provider who meets these criteria. The referring physician/provider may then send this information to the patient so they may make an appropriate and convenient appointment. The referring physician/provider may, instead, send the information to the referral physician/provider, or their staff, so that they may make the appointment using databases available via the central controller 185 and send, or cause, that information to be sent to the patient. The referring physician/provider may, instead, select a further option in which they, or their staff, so make the appointment using databases available via the central controller 185 and themselves send, or cause, that information to be sent to the patient.

The user may also select the recipient to be a viewing facility, i.e., a device to display data or video. The viewing facility may, for instance, be a device such as, but not limited to, a specific video monitor, a specific video projector, a specific mobile display device or some combination thereof.

Accessing the databases, or sending information to patients may, for instance, be done by looping back to step 3003 “Create message and optionally set time for response” and follow the flow chart from there. In this manner an encrypted electronic message that is a referral of an identified patient, or an appointment for a procedure, may be sent by an authorized user of the controlled, integrated digital communications system to a hospital operated facility, a hospital recognized specialist, or some combination thereof.

If the function selected in step 3010 is either “Billing” or “Pharmacy Formulary”, the authorized user may be presented with a menu that allows them to select from hospital system databases to access current information and/or complete forms within a secure digital environment.

The pharmacy formulary database may, for instance, provide physician/providers and other ordering providers with access via the App to current hospital formulary information that may, for instance, be a list of all medication available through the hospital, or system, pharmacy. In this manner, hospital systems may be able to highlight generic medication and other hospital or administration preferred medication for ordering by the provider. This function may be designed to reduce the use of non-formulary medication that may be equally effective but more costly, and increase the use generic medication that may be equally effective but less expensive. The financial considerations of such choices to hospital systems may be considerable.

The Billing and Formulary databases may also provide appropriate forms or menus for completing, supplying or accessing relevant information or for ordering pharmaceuticals, and/or assistance.

As before, accessing the databases, or sending information to administrators, may, for instance, be done by looping back to step 3003 “Create message and optionally set time for response” and follow the flow chart from there. In this manner an encrypted electronic messages may access and provide the required functionality.

The controlled, integrated digital communications system of the present invention may have further functions such as, but not limited to, locating physician/providers and/or their mobile smart-devices 115, assisting in audits of mobile smart-devices, and in dealing with the theft of loss of mobile smart-devices by methods such as, but not limited to, sending instructions from a central controller to lock a mobile smart-device, or requiring that further use of a device may require first reporting to a particular administrator along with the device.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. A controlled, integrated digital communications system, comprising:
machine executable instructions to enable a mobile smart-device to perform functions comprising:
verifying a user identity of an authorized user of said mobile smart-device;
securely encrypting an electronic message regarding a patient having a patient identity prior to transmitting said electronic message to an identified recipient;
receiving an electronic confirmation of receipt from said identified recipient;
tagging said electronic message with information comprising said user identity, said patient identity and said electronic confirmation of receipt; and
storing said tagged electronic message in a secure digital storage unit operated by a healthcare system.

2. the controlled communications system of claim 1, further comprising machine executable instructions to enable said mobile smart-device to perform functions comprising:
receiving an encrypted electronic message;
decrypting said electronic message; and
transmitting said electronic confirmation of receipt.

3. The controlled communications system of claim 2, further comprising machine executable instructions to enable said mobile smart-device to perform functions comprising:
automatically associating said tagged electronic message with a designated record set associated with said identified patient.

4. The controlled communications system of claim 3 wherein said encrypted electronic message is HIPAA compliant.

5. The controlled communications system of claim 3 wherein said encrypted electronic message comprises a referral of said identified patient by said authorized user to a hospital operated facility.

6. The controlled communications system of claim 3 wherein said encrypted electronic message comprises a referral of said identified patient by said authorized user to a hospital system recognized physician/provider.

7. The controlled communications software application of claim 3, further comprising machine executable instructions to enable said mobile smart-device to perform functions comprising:
specifying a specific period of time that may elapse from the transmission of said message until said mobile smart device is alerted to a receipt of said electronic message by an intended recipient.

8. The controlled communications software application of claim 3, wherein said encrypted electronic message comprises healthcare provider billing information.

9. The controlled communications system of claim 8 wherein said hospital system recognized physician/provider is a specialist in a particular medical specialty.

10. The controlled communications system of claim 8 wherein said hospital system recognized specialist is a specialist that participates in a medical insurance plan for which said identified patient is eligible.

11. The controlled communications software application of claim 3 wherein said encrypted electronic message is a patient procedure scheduling request.

12. The controlled communications software application of claim 3 wherein said encrypted electronic message is a pharmacy formulary inquiry or a pharmacy formulary request or a combination thereof.

13. The controlled communications system of claim 3 wherein said encrypted electronic message is a request for instant help to be sent to a particular location within a hospital system.

14. The controlled communications system of claim 3 wherein said encrypted electronic message is a communication from a first hospital personnel or physician/provider to a second hospital personnel or physician/provider.

15. The controlled communications system of claim 3, further comprising:
machine executable instructions to enable a mobile smart-device to perform functions comprising. receiving instructions from a central controller to lock said mobile smart-device.

16. The controlled communications system of claim 3 wherein said encrypted electronic message is a continuing medical education video.

17. The controlled communications system of claim 16 wherein said continuing medical education video is delivered to a specific display device.
